(19) United States
(12) Patent Application Publication
(10) Pub. No.: US 2009/0013107 A1
(43) Pub. Date: Jan. 8, 2009

(54) Method for Safe Data Transmission Between an Intrinsically Safe Sensor and a Non-Intrinsically Safe Evaluation Unit

(76) Inventor: Detlev Wittmer, Maulbronn (DE)

Correspondence Address: BACON & THOMAS, PLLC, 625 SLATERS LANE, FOURTH FLOOR, ALEXANDRIA, VA, 22314-1176, US

(21) Appl. No.: 10/572,934

(22) PCT Filed: Sep. 20, 2004
(86) PCT No.: PCT/EP04/10528

§ 371 Date: Dec. 13, 2007

(30) Foreign Application Priority Data
Sep. 23, 2003 (DE) 103 44 263.4

(51) Int. Cl. G06F 13/12

(52) U.S. Cl. 710/69

(57) ABSTRACT

In a method for safe data transfer between an intrinsically safe sensor and a non-intrinsically safe computer unit, data transfer occurs via an interface embodied as an Ex-barrier, or via a portable storage medium.

The invention relates to a method for safe data transmission between an intrinsically safe sensor and a non-intrinsically safe evaluation unit.

In the field of process automation technology, sensors register various process variables and transmit the corresponding digital measurement values to an evaluation unit (e.g. control station), in which the measurement values are stored and, if necessary, further processed.

Such sensors, especially potentiometric sensors, are frequently used in areas protected from explosion (Ex-zones). Potentiometric sensors are normally suitable for use in Ex-zones. However, evaluation of the measured values often takes place in computer units such as PCs (personal computers), which are not suitable for use in Ex-zones. There are also PCs which are suitable for use in Ex-zones, but such are very expensive.

Therefore, an object of the present invention is to provide a method for safe data transmission between an intrinsically safe sensor and a non-intrinsically safe evaluation unit, which method is simple and cost-efficient to execute.

This object is achieved through the process steps defined in the independent claims.

Advantageous further developments of the invention are presented in the dependent claims.

The invention will now be described in greater detail on the basis of multiple examples of embodiments illustrated in the drawings, the figures of which show as follows:

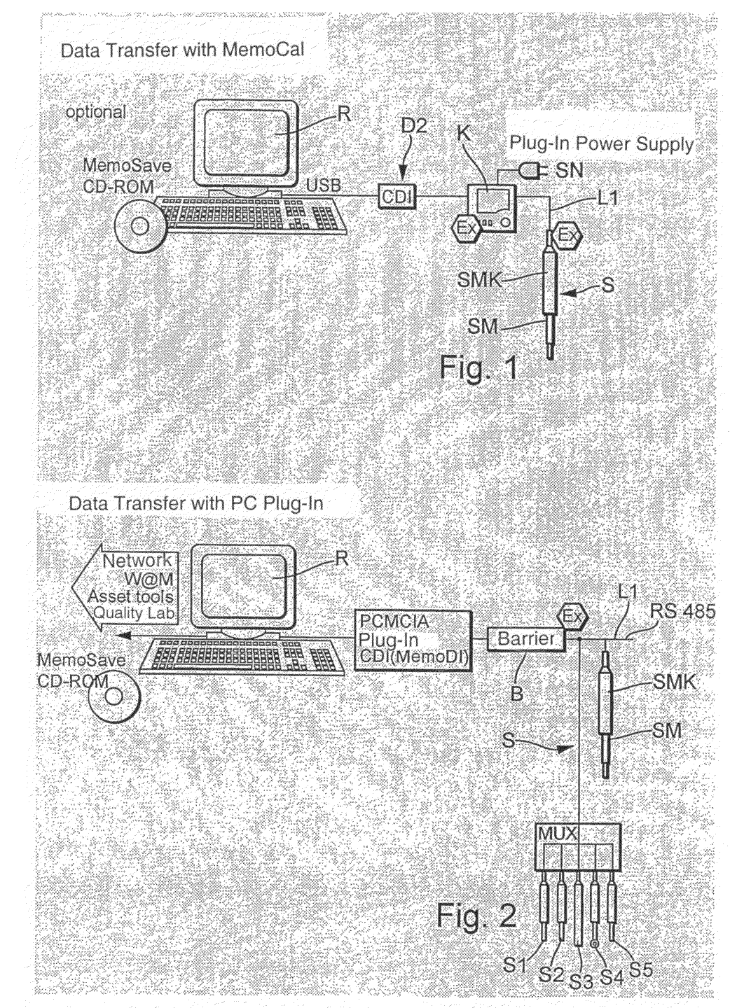

FIG. 1 schematic illustration of a computer unit which exchanges data with a sensor via an interface;

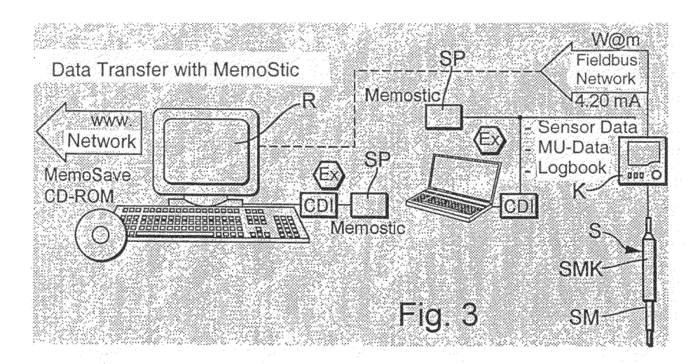

FIG. 2 schematic illustration of a computer unit which exchanges data with a sensor via a plug-in module; and

FIG. 3 schematic illustration of a computer unit which exchanges data with a sensor via a portable storage medium.

In FIG. 1, the illustrated sensor S is a liquid or gas sensor, especially a potentiometric sensor, which is composed of a sensor-module SM and a sensor-module head SMK. Sensor-module SM and sensor-module head SMK enable the transfer of data and energy via a galvanically decoupled transfer path. The sensor S is connected with a calibration unit K via a line L1. With the help of the calibration unit K, a calibration of sensors is possible. In addition to the calibration data, the measuring point name for the sensor S can be entered, and transferred via the line L1 to a memory provided in the sensor-module SM.

The voltage supply for the calibration unit occurs via a plug-in power supply SN.

As indicated in FIG. 1, calibration unit K and sensor S are both suitable for use in Ex-zones, and, thus, are designed to be intrinsically safe.

The computer unit R can be a personal computer, notebook, or laptop.

Calibration unit K is connected with a computer unit (personal computer, or PC) R via a data line D2, in which an interface CDI is provided. Data transfer on the PC-side occurs in accordance with the USB (universal serial bus) standard. On the sensor-side, data transfer on the data line D2, as well as on the line L1, occurs according to a proprietary protocol via an RS485 interface.

Data transfer between the computer unit R and the sensor S is achieved by steps as follows:
A. Converting the analog measured values into digital measurement data in the sensor-module SM of sensor S;
B. transferring the digital measurement data to the sensor-module head SMK of the sensor S via a galvanically decoupled transfer path, after which the measurement data is forwarded to the calibration unit K;
C. transferring the measurement data from the calibration unit K to the interface CDI, which serves as an Ex-barrier; and
D. transferring the measurement data from the interface CDI to the computer unit R via a standard interface (e.g. a USB interface) provided at the computer unit R.

FIG. 2 shows a connection between the sensor S and the computer unit R via a PCMCIA plug-in card. PCMCIA-card slots are frequently provided on today's personal computers. In the illustrated case, the sensor S is connected with an Ex-barrier B and the PCMCIA plug-in module via a line L1. Furthermore, the line L1 is connected with a multiplexing unit MUX, to which additional sensors S1, S2, S3, S4, S5 are connected. In this case, the data transfer also takes place via line L1, on the basis of a proprietary protocol. As illustrated in FIG. 2, the computer unit R allows connection with additional communication networks (Internet, intranet, company networks).

In FIG. 2, the data transfer between the sensor S, or the sensors S1-S5, as the case may be, and the computer unit R occurs via the PCMCIA plug-in card, constructed as a plug-in module for a computer unit R. The Ex-barrier can, in simple manner, be integrated into the plug-in module. The galvanic separation in the Ex-barrier B usually occurs either optically (by means of an optocoupler), or capacitively, or inductively, as the case may be. When a plug-in module with an Ex-barrier is used, sensors can easily be directly connected with a computer unit.

Data transfer between the computer unit R and the sensor S occurs by steps as follows:
A. Converting the analog measured values into digital measurement data in the sensor-module SM of sensor S; and
B. transferring the digital measurement data to the sensor-module head SMK of the sensor S via a galvanically decoupled transfer path, and further to the plug-in module PCMCIA of the computer unit R, with the plug-in module PCMCIA being embodied as an Ex-barrier.

FIG. 3 shows in greater detail a further possibility for data transfer between a sensor S and a computer unit R. In this case, the calibration unit K has an additional data interface (fieldbus, network, 4-20 mA). In addition, the calibration unit K has a port for a portable storage medium SP. The computer unit PC also has the capability for the portable storage medium SP to connect via the interface CDI, which is already described with reference to FIG. 1.

Data transfer between the computer unit R and the sensor S occurs with steps as follows:
A. Converting the analog measured values into digital measurement data in the sensor-module SM of sensor S;
B. transferring the digital measurement data to the sensor-module head SMK of the sensor S via a galvanically decoupled transfer path, and further to the calibration unit K;
C. saving the measurement data to the portable storage medium SP, which is separable from the calibration unit K;
D. transporting the storage medium SP in separated state to the computer unit R;
E. connecting the storage medium SP to the computer unit R; and
F. transferring the measurement data to the computer unit R via a standard interface (e.g. a USB interface) provided at the computer unit R.

With the aforementioned method, it is possible to simply exchange data between the intrinsically safe sensor S and the non-intrinsically safe computer unit R. In all of the cases described, data transfer can occur in both directions, e.g. from sensor S to computer unit R, and from computer unit R to sensor S. In the computer unit R, different sensors and measuring points are managed. A graphic illustration of the history of the sensor is possible at the computer unit R, and an assessment of the life span of an electrode in a sensor S can also occur therein. In the case of an on-site calibration, calibration data of a sensor S can be easily transferred to the computer unit for the sensor history.

1-6. (canceled)

7. A method for safe data transfer between an intrinsically safe sensor and a non-intrinsically safe computer unit, comprising the steps of:
converting analog measured values into digital measurement data in a sensor-module of the sensor;
transferring the digital measurement data to a sensor-module head of the sensor via a galvanically decoupled transfer path, and further to a calibration unit;
saving the measurement data to a portable storage medium which is separable from the calibration unit;
transporting the storage medium in a separated state to the computer unit;
connecting the storage medium with the computer unit; and
transferring the measurement data to the computer unit via a standard interface provided at the computer unit.

8. A method for safe data transfer between an intrinsically safe sensor and a non-intrinsically safe computer unit, comprising the steps of:
converting analog measured values into digital measurement data in a sensor-module of the sensor;
transferring the digital measurement data to a sensor-module head of the sensor via a galvanically decoupled transfer path, and further to a calibration unit;
transferring the measurement data from the calibration unit to an interface CDI, which is embodied as an Ex-barrier; and
transferring the measurement data from the interface CDI to the computer unit via a standard interface provided at the computer unit.

9. The method as claimed in claim 7, wherein:
the standard interface at the computer unit is a USB-interface.

10. The method as claimed in claim 7, wherein:
data transfer between the sensor and the calibration unit occurs with a proprietary protocol in accordance with the RS485 standard.

11. A method for safe data transfer between an intrinsically safe sensor and a non-intrinsically safe computer unit, comprising the steps of:
converting analog measured values into digital measurement data in a sensor-module of the sensor; and
transferring the digital measurement data to a sensor-module head of the sensor via a galvanically decoupled transfer path, and further to a plug-in module of the computer unit, with the plug-in module being embodied as an Ex-barrier.

12. The method as claimed in claim 11, wherein:
the plug-in module is a PCMCIA plug-in card.
